(19) United States
(12) Patent Application Publication
(10) Pub. No.: US 2005/0249229 A1
(43) Pub. Date: Nov. 10, 2005

(54) Dynamically scalable edge router

(75) Inventors: Richard Wilkie, Groton, MA (US); Michael Davis, Stittsville (CA); Mike Popp, Nepean (CA); Hamid Assarpour, Arlington, MA (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 11/069,778

(22) Filed: Mar. 1, 2005

Related U.S. Application Data
(60) Provisional application No. 60/569,079, filed on May 7, 2004.

(51) Int. Cl. H04L 12/28

(52) U.S. Cl. 370/422

(57) ABSTRACT

The present invention provides a dynamically scalable edge router, wherein multiple data cards are connected to multiple input/output (I/O) cards via a dynamically configurable cross point. The cross point can be reconfigured to establish different connections between the data cards and the I/O cards, as well as change or establish new connections when additional data cards or I/O cards are added to the edge router. Accordingly, the cross point cooperates with the I/O cards to establish specific connections to the various data cards. The data cards may be connected to each other through a packet fabric, wherein the I/O cards, the cross point, the data cards, and the packet fabric form a significant portion of the forwarding plane of the edge router. The control plane is substantially provided by control cards, which are connected to the data cards through an internal network, which may be a switched network.

This application claims the benefit of U.S. provisional patent application Ser. No. 60/569,079, filed May 7, 2004, the disclosure of which is hereby incorporated by reference in its entirety.

### FIELD OF THE INVENTION

The present invention relates to communications, and in particular to a unique platform for a multi-service edge router.

### BACKGROUND OF THE INVENTION

With the increasing expansion of the Internet and a desire to support multiple services, including audio, video, data, and voice, over packet networks, there is a need to provide scalability within network components. In particular, edge routers, which support the interworking and connections between disparate types of networks including access and core networks, would benefit from such scalability. As traffic increases within the networks and the need for traffic to travel between networks increases, the capabilities of the edge routers must increase to accommodate the ever-increasing demand to route traffic between the networks. Unfortunately, network providers are faced with either replacing edge routers on a regular basis or purchasing edge routers with significantly more capability than is currently needed to accommodate increases in demand. These options have proven to be excessively expensive and prohibitive in certain circumstances. Accordingly, there is a need for a readily scalable edge router platform in which various aspects of the edge router are incrementally scalable to accommodate demand.

Depending on a particular network's needs, the edge router may need additional control plane resources, forwarding plane resources, input or output ports, or a combination thereof. Thus, there is a need for an edge router that is capable of incrementally scaling control plane resources, forwarding plane resources, or input or output ports on an individual basis. There is a further need to provide a common platform from which such scalability is provided to afford a cost-effective solution that can be adapted or scaled for different applications and the needs of those applications.

### SUMMARY OF THE INVENTION

The present invention provides a dynamically scalable edge router, wherein multiple data cards are connected to multiple input/output (I/O) cards via a dynamically configurable cross point. The cross point can be reconfigured to establish different connections between the data cards and the I/O cards, as well as change or establish new connections when additional data cards or I/O cards are added to the edge router. Accordingly, the cross point cooperates with the I/O cards to establish specific connections to the various data cards. The data cards may be connected to each other through a packet fabric, wherein the I/O cards, the cross point, the data cards, and the packet fabric form a significant portion of the forwarding plane of the edge router. The control plane is provided by control cards, which are connected to the data cards through an internal network, which may be a switched network, such as a switched Gigabit Ethernet network. The switched network allows simultaneous communications between the control cards and the data cards. The control cards have one or more processing modules and the ability to receive additional processing modules when additional control plane processing is required. When additional processing modules are added, the processing may be distributed among the processing modules within a control card or among multiple control cards.

The control plane may control the connections established within the packet fabric as well as the cross point through separate or combined logic, which is capable of controlling the packet fabric or the cross point to establish the appropriate paths or connections therein. Accordingly, when additional processing modules, data cards, or I/O cards are added to the edge router, the connections within the cross point as well as the paths within the packet fabric may be reconfigured as necessary to support the new hardware as well as any new routing functionality. The control plane may run virtual routing and forwarding processes, which essentially provide a software router that controls the data cards such that routing is provided as desired through the data cards. The virtual routing and forwarding processes may be associated with certain types of traffic to be routed, a particular subscriber's traffic, or a group of subscribers' traffic, such that the traffic for the respective virtual routing and forwarding processes is effectively handled on an individual basis within the edge router. The edge router is capable of supporting multiple types of services, including data, audio, video, and voice, alone or in combination.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a block diagram of an edge router constructed according to one embodiment of the present invention.

FIG. 3 is a block diagram of a control plane and data plane according to one embodiment of the present invention.

FIG. 4 is a block diagram illustrating virtual routing and forwarding processes according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

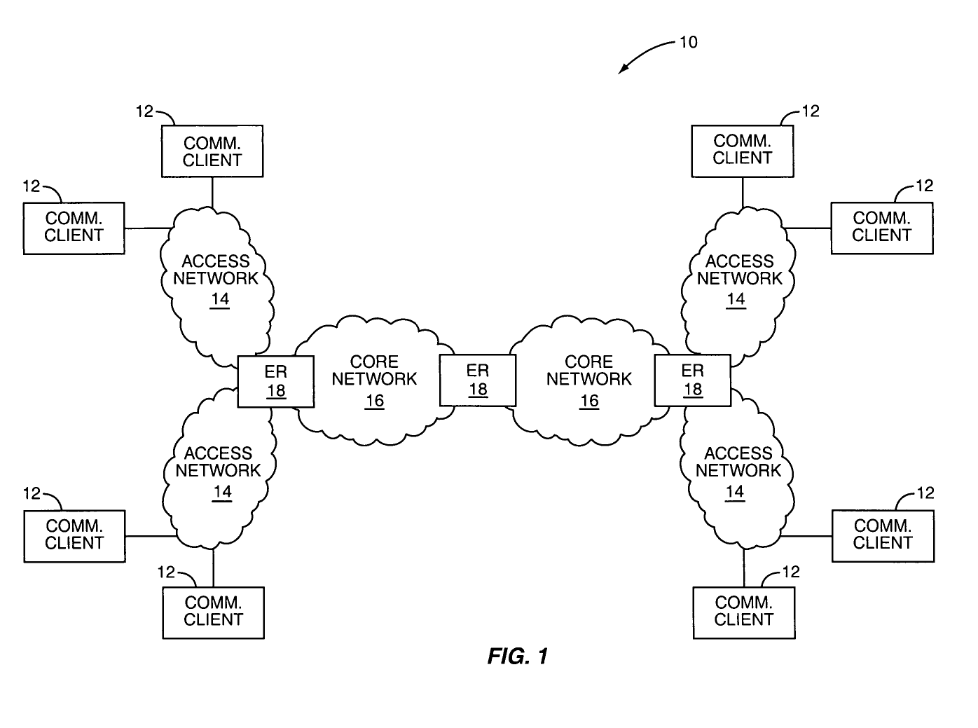

With reference to FIG. 1, a communication environment 10 is illustrated according to one embodiment of the present invention. In general, packet-based communications are provided between various communication clients 12 through supporting access networks 14, and perhaps core networks 16. Edge routers (ERs) 18 are used to connect the various access networks 14 to each other and to appropriate core networks 16. The edge routers 18 may also connect different core networks 16. The edge routers 18 are particularly useful in converting communications between the communication technologies used in the associated access networks 14 or core networks 16, as well as the supporting protocols. For example, an edge router 18 may connect digital subscriber line (DSL) or cable access networks 14 to an asynchronous transfer mode (ATM) or multi-protocol label switching (MPLS) core network 16, and vice versa. In general, the edge routers 18 reside at the edge of an access network 14 or core network 16 and are used to facilitate communications with these networks. The edge routers 18 will provide the necessary formatting or protocol translations to enable communications over the connected access networks 14 or core networks 16. The access networks 14 may include networks supporting wired or wireless communications, such as time division, duplex, cellular, cable, and digital subscriber line networks.

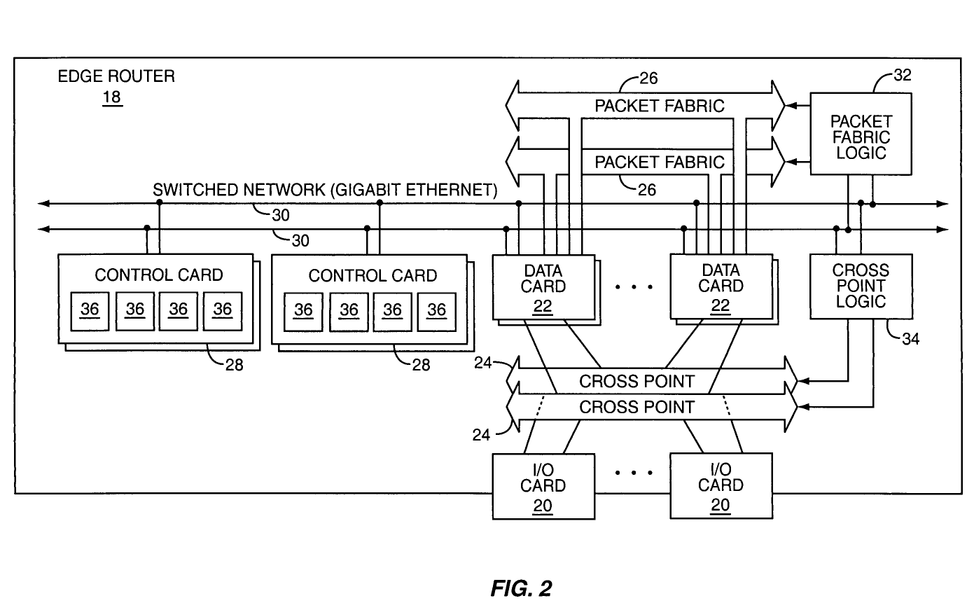

With reference to FIG. 2, the architecture of an edge router 18 is illustrated according to one embodiment of the present invention. As noted, the edge router 18 will interface with one or more access networks 14, core networks 16, or a combination thereof. The interface is provided through a number of input/output (I/O) cards 20, each of which provides numerous ports for sending and receiving traffic and control packets. Incoming traffic is received at a port on an I/O card 20 and sent to an appropriate data card 22 through a cross point network 24. The data card 22 may process the traffic and send it to an appropriate I/O card 20 via the cross point 24 for forwarding, or may send the processed traffic to another data card 22 via a packet fabric 26. The data card 22 will further process traffic and send it to an appropriate I/O card 20 via the cross point 24.

Control information may be received by the data card 22 via the I/O card 20 and cross point 24 and sent to a control card 28 over an internally contained switched network 30, such as a Gigabit Ethernet network. The switch network 30 may be constructed with several Ethernet switches acting in concert. The data cards 22 may include switches associated with the switched network 30 to provide communications among the various intelligent devices of the forwarding plane. Through the switched network 30, the switches of the data cards 22 will be connected to switches on the control cards 28 to form a redundant, high-speed, private network to maintain control and management functions, even under extreme loads. The switched network 30 also allows the separation of control traffic for various routes or sessions and allows for the isolation of potential problem areas from sensitive data.

The control cards 28 provide a significant part of the control plane for the edge router 18, and will cooperate with the data cards 22 to effectively control and configure the data cards 22 and process the traffic being routed in a desired fashion. Further, the control cards 28 may interact with packet fabric logic 32 and cross point logic 34 to effectively establish connections between the data cards 22 over the packet fabric 26, or establish connections between the data cards 22 and the I/O cards 20 via the cross point 24. Notably, the cross point 24 is dynamically configurable, such that virtually any port on any one of the data cards 22 can be connected to an appropriate port on any one of the I/O cards 20, as necessary for routing traffic and processing control packets. In addition to using the cross point 24 to connect the data cards 22 and the I/O cards 20, the cross point 24 can be used to establish direct connections between I/O cards 20. The ability to directly connect I/O cards 20 through the cross point 24 allows the I/O cards 20 to provide various functions, including encryption and decryption. As such, certain traffic may enter the edge router 18 and leave without having been directed through a data card 22. The I/O cards 20 may also provide various types of filtering to help determine an appropriate data card 22 or I/O card 20 to which traffic should be directed. Further, multiple I/O cards 20 may be daisy chained together through connections established via the cross point 24 to form more complex operations on the traffic. Sequential application of more sophisticated functionality may still be provided by one or more data cards 22, which may also be daisy chained together to provide a sequence of functions for traffic being routed through the edge router 18.

The data cards 22 make up a significant portion of the forwarding plane of the edge router 18, and function to make routing decisions and route traffic according to those decisions. Such routing control may include determining a next-hop or destination for packets being routed, enforcing routing policies for certain types of traffic, traffic for certain subscribers or groups of subscribers, and the like. The data cards 22 may also act to manage internal and network resources, which may include limiting or dropping packets based on any number of criteria.

The routing rules implemented by the data cards 22 are generally received from the control cards 28 over the switched network 30. Upon being configured with these routing rules, the data cards 22 will receive incoming traffic directly from an I/O card 20 over the cross point 24, or indirectly from the I/O card 20 via another data card 22, and then forward the traffic over the packet fabric 26 to an appropriate data card 22 or directly to an I/O card 20 via the cross point 24.

In operation, the data cards 22 may communicate with each other, including forwarding traffic therebetween, using the Internet Protocol (IP). Each data card 22 may provide any conversion between communication formats. For example, traffic coming into one data card 22 may be in an ATM format, be processed and forwarded to another data card 22 over the packet fabric 26 using IP, and then be converted to an MPLS format for forwarding. Alternatively, a single data card 22 may be able to receive and transmit using different formats. For example, incoming traffic in an Ethernet format may be processed and forwarded in an ATM format, and vice versa. Thus, the data cards 22 may operate alone or in conjunction with other data cards 22 to facilitate the requisite processing for routing between disparate networks. The data cards 22 are dynamically configurable, and may be dynamically connected to any port on any I/O card 20 upon dynamically configuring the cross point 24.

The switched network 30 is different from a typical Ethernet-based network in the sense that multiple entities, such as the control cards 28, data cards 22, packet fabric logic 32, and cross point logic 34, may communicate with each other in a simultaneous fashion, wherein multiple communications may take place at the same time. The switch configuration for the switched network 30 allows the edge router 18 to provide full, non-blocking behavior and the ability to distribute control signals and control processing throughout the edge router 18 to optimize efficiency.

The edge router 18 depicted in FIG. 2 provides significant failure detection, as well as efficient scalability. Failover protection is afforded by providing redundancy for the control cards 28, the data cards 22, the cross points 24, the packet fabric 26, and the switched network 30. Further, paths in the packet fabric 26 or connections provided by the cross point 24 can be dynamically restructured upon a failure to essentially bring a backup card online.

The edge router 18 is designed for reconfiguration and scalability. For example, the number of data cards 22 and I/O cards 20 may vary. Additional data cards 22 or I/O cards 20 may be added as necessary, wherein the packet fabric 26 and the cross point 24 are reconfigurable to accommodate the necessary connections. In certain embodiments, the edge router 18 may require a large number of I/O and thus a large number of I/O cards 20, and only a limited number of data cards 22. In other embodiments, additional processing required for forwarding will dictate a larger number of data cards 22, wherein the number of I/O may vary from a small to a large number. Importantly, data cards 22 and I/O cards 20 may be added after the edge router 18 is placed into service, and the cross point 24 and packet fabric 26 can be reconfigured to establish the appropriate paths or connections in a dynamic fashion.

In addition to providing scalability for the forwarding plane and the associated I/O, the edge router 18 provides significant scalability for the control plane, which resides predominantly in the control cards 28 and to a significantly lesser extent in the data cards 22. In particular, the number of control cards 28 may vary, and additional control cards 28 can be added to the edge router 18. As with the existing control cards 28, any new control cards 28 will connect to the switched network 30 so that communications with the data cards 22 as well as the packet fabric logic 32 and cross point logic 34 may be facilitated. The processing capabilities of the various control cards 28 may be controlled in incremental steps because each control card 28 will include the capability to receive additional processing modules 36. On a given control card 28, the available processing modules 36 may cooperate with each other to share the processing burden of the control plane 28 as necessary for the particular control card 28. As such, the processing capability afforded by the control plane of the edge router 18 may be scaled throughout the life of the edge router 18 by adding processing modules 36, and if necessary, additional control cards 28, which may provide further scalability by being able to receive incremental processing resources upon adding processing modules 36.

From the above, the edge router 18 in the present invention provides significant scalability in an independent fashion for the control plane and the forwarding plane, including scalability for I/O. Depending on the control plane and forwarding plane resources, as well as the number of I/O cards 20 and associated ports, the cross points 24 can be configured dynamically to accommodate additional data cards 22 or I/O cards 20, as well as provide a failover mechanism to dynamically reconfigure connections between the data cards 22 and the I/O cards 20 upon a failure of a data card 22 or I/O card 20. The packet fabric 26 may be reconfigured in a similar fashion. The switched network 30 allows efficient communications between the control cards 28 and the respective data cards 22, packet fabric logic 32, and cross point logic 34 by providing significant bandwidth as well as supporting simultaneous communications, without requiring the respective communicating entities to wait for network availability prior to communicating with each other. Thus, the connections between the data cards 22 and the I/O cards 20 are not fixed and are effectively under software control, thereby avoiding static connections between the data cards 22 and the I/O cards 20 as provided in traditional routers and switches. The packet fabric 26 and the cross point 24 may be provided on separate or common cards, which may or may not include the requisite packet fabric logic 32 and cross point logic 34 for dynamically configuring the respective paths and connections. Further, the packet fabric logic 32 and the cross point logic 34 may be combined in a common control circuit or module. The edge router 18 will include an appropriate backplane for facilitating the connection of each of the elements described above.

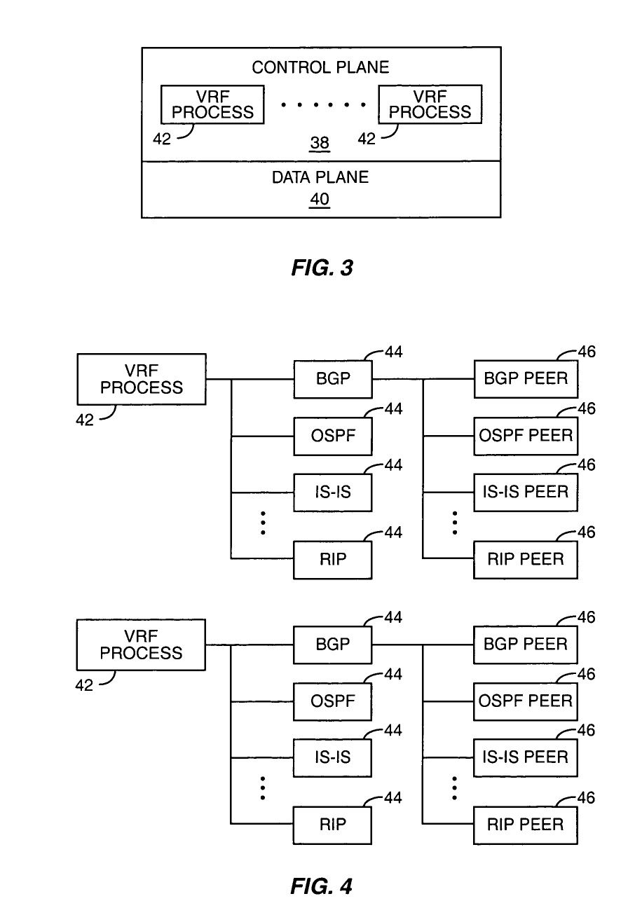

Turning now to FIG. 3, a block diagram is provided of a control plane 38 and a data plane 40. Again, the control plane 38 includes the control cards 28 and a portion of the control aspects of the data cards 22, whereas the data plane 40 will encompass the remainder of the data cards 22, as well as the I/O cards 20. For a given communication session, type of traffic, subscriber's traffic, or group's traffic, a virtual routing and forwarding process may be established to effectively provide a private routing service within the edge router 18. If each subscriber or group of subscribers has a virtual routing and forwarding process, different ones of the virtual routing and forwarding processes can be allocated to one or distributed among multiple control cards 28. The virtual routing and forwarding process will function to configure the appropriate data card or cards 22, the I/O card or cards 20, and the cross point 24, to facilitate the appropriate connections between the data cards 22 and the I/O cards 20 to provide forwarding of traffic through the edge router 18 as well as the direction of control information to the appropriate control card 28.

Since the virtual routing and forwarding process is essentially a private software router for a given type of traffic, subscriber's traffic, or group of subscribers' traffic, different types of traffic may need to be handled by the virtual routing and forwarding process. These different types of traffic may take on different formats and use different protocols, depending on the access network 14, core network 16, or communication technologies involved. As illustrated in FIG. 4, different virtual routing and forwarding processes (VRF) 42 may support different protocols 44 for communicating with different communication peers 46, such as the Border Gateway Protocol (BGP) based peer 46. Different peers may use different ones of the protocols. Other protocols illustrated merely for exemplary purposes include Open Shortest Path First (OSPF), Intermediate System-to-Intermediate System (IS-IS), and Routing Information Protocol (RIP). As such, a given virtual routing and forwarding process may allow routing using different protocols with a conversion between different protocols, to and from various types of communication peers. In one embodiment, each virtual routing and forwarding process is a unique Linux process.

Those skilled in the art will recognize improvements and modifications to the preferred embodiments of the present invention. All such improvements and modifications are considered within the scope of the concepts disclosed herein and the claims that follow.

1. An edge router comprising:
a plurality of data cards providing part of a forwarding plane;
a plurality of input/output cards providing input and output ports;
a selectively configurable cross point adapted to provide desired connections between the plurality of data cards and the plurality of input/output cards;
a packet fabric adapted to provide desired connections between the plurality of data cards; and
at least one control card providing part of a control plane and adapted to interact with the plurality of data cards to control the forwarding plane for routing packet traffic.

2. The edge router of claim 1 wherein the selectively configurable cross point is adapted to dynamically reconfigure the desired connections between the plurality of data cards and the input/output cards.

3. The edge router of claim 1 wherein the desired connections are reconfigured based on instructions from the control plane.

4. The edge router of claim 3 further comprising cross point logic adapted to control the cross point to establish the desired connections based on the instructions from the control plane.

5. The edge router of claim 1 wherein when additional data cards are added to the edge router, the cross point is adapted to dynamically establish desired connections between the additional data cards and the input/output cards.

6. The edge router of claim 1 wherein when additional input/output cards are added to the edge router, the cross point is adapted to dynamically establish desired connections between the plurality of data cards and the additional input/output cards.

7. The edge router of claim 1 further comprising a switched network adapted to facilitate simultaneous communications between the at least one control card and the plurality of data cards.

8. The edge router of claim 7 further comprising packet fabric logic and cross point logic, and wherein the switched network is further adapted to facilitate communications between the at least once control card, the plurality of data cards, the packet fabric logic, and the cross point logic.

9. The edge router of claim 1 wherein the at least one control card comprises at least one processing module and is adapted to receive additional processing modules as processing resources for the control plane increase.

10. The edge router of claim 9 wherein the additional processing modules cooperate with the at least one processing module to provide processing for the control plane.

11. The edge router of claim 1 wherein the control plane is adapted to run a plurality of virtual routing and forwarding processes, each adapted to provide a software router function within the control plane and control select ones of the plurality of data cards to route packets according to defined rules.

12. The edge router of claim 11 wherein the virtual routing and forwarding processes are associated with one of the group consisting of a type of traffic, a subscriber's traffic, and a group of subscribers' traffic.

13. The edge router of claim 1 further comprising a redundant control card and a plurality of redundant data cards adapted to operate upon a failure of a corresponding one of the at least one control card or the plurality of data cards.

14. The method of claim 13 wherein the cross point is adapted to dynamically reconfigure the desired connections to an appropriate one of the plurality of redundant data cards with the input/output cards upon a failure of one of the plurality of redundant data cards.

15. The method of claim 14 wherein the control plane is adapted to detect the failure and initiate reconfiguration of the desired connections to an appropriate one of the plurality of data cards with the input/output cards.

16. The edge router of claim 1 wherein the cross point is further adapted to establish connections between the plurality of input/output cards.

17. An edge router comprising:
a plurality of data cards providing part of a forwarding plane;
a plurality of input/output cards providing input and output ports;
a selectively configurable cross point adapted to provide desired connections between the plurality of data cards and the plurality of input/output cards, wherein the selectively configurable cross point is adapted to dynamically reconfigure the desired connections between the plurality of data cards and the input/output cards;
a packet fabric adapted to provide desired connections between the plurality of data cards;
at least one control card providing part of a control plane and adapted to interact with the plurality of data cards to control the forwarding plane for routing packet traffic; and
a switched network adapted to facilitate simultaneous communications between the at least one control card and the plurality of data cards.

18. The edge router of claim 17 wherein the desired connections are reconfigured based on instructions from the control plane.

19. The edge router of claim 18 further comprising cross point logic adapted to control the cross point to establish the desired connections based on the instructions from the control plane.

20. The edge router of claim 17 wherein when additional data cards are added to the edge router, the cross point is adapted to dynamically establish desired connections between the additional data cards and the input/output cards.

21. The edge router of claim 17 wherein when additional input/output cards are added to the edge router, the cross point is adapted to dynamically establish desired connections between the plurality of data cards and the additional input/output cards.

22. The edge router of claim 17 further comprising packet fabric logic and cross point logic, and wherein the switched network is further adapted to facilitate communications between the at least once control card, the plurality of data cards, the packet fabric logic, and the cross point logic.

23. The edge router of claim 17 wherein the at least one control card comprises at least one processing module and is adapted to receive additional processing modules as processing resources for the control plane increase.

24. The edge router of claim 23 wherein the additional processing modules cooperate with the at least one processing module to provide processing for the control plane.

25. The edge router of claim 17 wherein the control plane is adapted to run a plurality of virtual routing and forwarding processes, each adapted to provide a software router function within the control plane and control select ones of the plurality of data cards to route packets according to defined rules.

26. The edge router of claim 25 wherein the virtual routing and forwarding processes are associated with one of the group consisting of a type of traffic, a subscriber's traffic, and a group of subscribers' traffic.

27. The edge router of claim 17 further comprising a redundant control card and a plurality of redundant data cards adapted to operate upon a failure of a corresponding one of the at least one control card or the plurality of data cards.

28. The method of claim 27 wherein the cross point is adapted to dynamically reconfigure the desired connections to an appropriate one of the plurality of redundant data cards with the input/output cards upon a failure of one of the plurality of data cards.

29. The method of claim 28 wherein the control plane is adapted to detect the failure and initiate reconfiguration of the desired connections to an appropriate one of the plurality of data cards with the input/output cards.

30. The edge router of claim 17 wherein the cross point is further adapted to establish connections between the input/output cards.
